(19) United States
(12) Patent Application Publication
(10) Pub. No.: US 2006/0249214 A1
(43) Pub. Date: Nov. 9, 2006

(54) Conduit, preferably a flexible hose

(75) Inventors: Karl Haschka, Grundau (DE); Thomas Rosch, Linsengericht-Grossenhausen (DE)

Correspondence Address: BUCHANAN, INGERSOLL & ROONEY PC, POST OFFICE BOX 1404, ALEXANDRIA, VA, 22313-1404, US

(73) Assignee: VERITAS AG, Gelnhausen (DE)

(21) Appl. No.: 11/402,813

(22) Filed: Apr. 13, 2006

(30) Foreign Application Priority Data
Apr. 14, 2005 (DE) 102005017318.7

(51) Int. Cl. F16L 11/00

(52) U.S. Cl. 138/109; 138/125; 138/137

(57) ABSTRACT

The invention relates to a conduit, preferably a flexible hose, which is, at least sectionwise, provided with an eversion in an end portion thereof, said conduit having been everted in a plastic state prior to a solidification by means of which said eversion is fixed; in addition, the invention relates to a method for producing such a conduit.

The invention relates to a conduit, preferably a flexible hose, according to the preamble of claim 1 and to a method of producing the same.

Such conduits are known from the prior art in a great variety of embodiments and are used e.g. in the fields of building services, mechanical engineering and automotive engineering. Preferably, these conduits are used for establishing flexible connections and they are implemented as flexible hoses. They normally interconnect various components and they preferably serve to convey liquids or gases.

The connections of such a hose to another component frequently represent a critical element. In many cases, hose attachment nipples with hose clamps are used for connecting hoses to other components. This mode of connection has, however, a plurality of disadvantages, such as laborious mounting, the risk that the hose clamp may become loose or slip off, notch effects on the attachment nipple and the hose clamp, lack of resistance to tractive forces and lack of scouring resistance, problems arising when the connection is subjected to thermal stresses, the necessity of disassembling and checking the connection at regular intervals, narrowing of the lumen by the hose attachment nipple located in the interior of the flow cross-section.

It is therefore the object of the present invention to provide a conduit, in particular a flexible hose, which can reliably be connected to other components. Furthermore, a method for producing such a conduit is to be provided.

According to the present invention, this object is achieved by a conduit, preferably a flexible hose, which is, at least sectionwise, provided with an eversion in an end portion thereof, said conduit having been everted, i.e. folded back or folded inwards, in a plastic state prior to a solidification by means of which said eversion is fixed.

One advantage of the present invention is to be seen in that the conduit is stabilized in the everted area. Another advantage is that, due to the eversion, a gripping edge is formed on the conduit. A further advantage of the conduit according to the present invention also resides in the fact that various sealing surfaces are formed on the conduit in the everted area. Another important advantage is that the conduit according to the present invention can easily be mounted to a suitable conduit connection piece and can establish a reliable connection. The present invention is also advantageous insofar as a connection of the conduit according to the present invention to a suitable connection piece will not result in a narrowing of the lumen of the flow cross-section. Another important advantage of the subject matter of the present invention is that a connection between the conduit according to the present invention and a suitable conduit connection piece can be established in a particularly reliable manner and that this connection can be relied on during long-term use. A further advantage of the conduit according to the present invention is to be seen in that this conduit can be produced easily and at a reasonable price.

According to a preferred embodiment of the conduit according to the present invention, a section of the eversion can be in contact with the conduit on a non-everted portion, whereby the everted area will be supported and stabilized.

Another embodiment of the present invention is so conceived that, after the eversion, the everted portion can be in contact with the non-everted portion of the conduit only in a section including the conduit end, whereby in particular the rear edge of the eversion will be specially stabilized and rendered suitable for mounting in a conduit connection piece, whereas the residual area of the eversion can be maintained flexible.

According to another embodiment, the eversion can be implemented such that a section of an everted portion located on the side of the conduit end terminates in a straight portion, whereby a force acting on the conduit end in a direction parallel to the conduit will be transmitted more effectively to the bent area of the eversion.

According to another preferred embodiment, the eversion can be carried out such that an everted area located on the side of the conduit end terminates in a parallel portion, said parallel portion being implemented such that the respective wall layers of a non-everted portion and of an everted portion extend substantially parallel to one another in this area. In the case of this embodiment, a larger part of the everted area is stabilized. In addition, the rear edge of the everted area is more suitable for introducing therein a pressing force which is directed axially towards the connection piece.

In accordance with another embodiment, the everted portion can be implemented such that it is not in contact with the non-everted portion, whereby the everted portion can be maintained particularly flexible and devices can be inserted in the annular gap defined between the everted portion and the continuative portion of the conduit.

A particularly advantageous embodiment may be so conceived that the eversion has been performed outwards so that the original outer conduit walls of the non-everted portion and of the everted portion face one another. This allows the rear edge of the eversion to be located outside of the hose cross-section and it allows some other component to engage behind said rear edge outside of the hose lumen, or to engage below said rear edge outside of the hose lumen or to encompass it outside of the hose lumen, whereby an impairment of the flow cross-section will be avoided.

According to another embodiment, a conduit end can be everted more than once, whereby more than two wall layers will adjoin one another in the everted area thus guaranteeing a particularly high degree of stabilization and a particularly strong increase in the thickness of the end section.

In accordance with another special embodiment, the eversion can be performed by rolling in the conduit end, whereby the wall layers in the everted area will be arranged in an approximately spiral mode of arrangement, when seen in a cross-sectional view, thus achieving a particularly distinct rounding and radial stabilization of the everted area.

According to a preferred embodiment, the conduit may include in the everted area at least one stabilizing means by means of which the eversion can be stabilized. This allows the eversion to be specially stabilized and optimized for the respective intended use.

According to an advantageous embodiment, this stabilizing means can be arranged in the everted area, at least sectionwise, between the wall layers of the non-everted portion and of the everted portion, whereby the conduit is stabilized in the everted area in particular in the radial direction.

In accordance with another embodiment, the stabilizing means can be in contact with the conduit end at the cut edge thereof, whereby axial forces can more effectively be introduced in the everted area. This can be of advantage, e.g. when an end face of the everted area is pressed against a conduit end section so as to be brought into sealing contact therewith.

Furthermore, the stabilizing means can encompasses the everted portion at the inner conduit side facing outwards, whereby the everted area is stabilized in its entirety and protected against widening.

According to a particularly advantageous embodiment, the stabilizing means can be implemented as an encompassing means for encompassing the eversion end area; the use of a sleeve, preferably a metal sleeve, will here be preferred. By encompassing the eversion end area, said end area can be stabilized in a particularly reliable manner, a deformation thereof can be avoided and the bent area of the eversion can simultaneously be maintained flexible, whereby a particularly easily adaptable, large and reliable contact area will be obtained between the bent area of the eversion and a conduit connection piece.

According to an advantageous further development, the conduit according to the present invention can be a flexible hose and it can contain at least an elastomer, a thermoplastic elastomer or a thermoplastic, the eversion being executed prior to a vulcanization or polymerization. The use of such a hose allows the conduit connection to be maintained flexible and the everted area can also establish a particularly reliable sealing with regard to an adjoining component, e.g. a conduit connection piece.

In accordance with an advantageous embodiment, this flexible hose can be produced in an extrusion process, whereby a particularly advantageous production with regard to operating efficiency and costs will be possible.

According to a preferred embodiment, this flexible hose can be implemented as a multi-layered hose of fabric comprising at least an inner layer, a reinforcement layer and an outer layer, said inner layer and/or outer layer containing an elastomer, a thermoplastic elastomer or a thermoplastic. When a hose of fabric having this structural design is used, the hose will resist higher loads.

In accordance with an advantageous further development, the flexible hose can include a blocking layer thus making the hose suitable for special cases of use by increasing the diffusion resistance to chemicals, whereby e.g. the layers supporting the hose mechanically can be protected against aggressive chemicals or said chemicals can be prevented from escaping into the environment.

In accordance with a special further development, this blocking layer is arranged on the inner side of the hose thus increasing the diffusion resistance to aggressive chemicals conveyed in the hose interior, whereby e.g. the layers supporting the hose mechanically can be protected against these chemicals and whereby the hose can be sealed in a particularly reliable manner from a connection piece via the blocking layer which is in contact with said connection piece.

A blocking layer containing a rubber copolymer or a halogen-containing rubber, preferably fluorocarbon rubber, can prove to be particularly advantageous in this respect. A blocking layer containing these materials has e.g. a particularly high resistance to chemicals, e.g. to a large number of hydrocarbon compounds.

In the case of a preferred embodiment, the flexibility of the conduit in the everted area may not exceed that of a continuative portion, whereby a better stabilization of the everted area will be achieved.

According to a preferred embodiment, the everted area of the conduit can include a sealing area comprising a sealing means, whereby this area can be implemented such that it will be particularly suitable for executing a sealing function.

According to an advantageous embodiment, this sealing means can represent a sealing lip, said sealing lip being formed by incising the conduit wall after the vulcanization or the polymerization according to a preferred embodiment.

In accordance with a preferred embodiment, the preferred ratio of the length of the everted area to the wall thickness of the conduit can be between 2.5:1 and 20:1, whereby dimensional relationships will be obtained, which are suitable for achieving a good stabilizing effect on the eversion.

Furthermore, the conduit can be implemented as an adapter in another preferred embodiment, said conduit being then provided with an eversion on both ends thereof. The conduit can thus establish a connection between two adjoining components and interconnect them.

According to a preferred embodiment, the adapter can be implemented such that the ratio of adapter length to conduit internal diameter is typically smaller than 10:1, preferably smaller than 3:1. Such adapters can advantageously be used for providing mechanical, thermal or electrical decoupling of components, for damping vibration transmission from one component to the next, for acoustic decoupling, as a damping element for absorbing pressure peaks in a medium conveyed through the adapter, for compensating tolerances and thermal stresses. Such an adapter can be used in a particularly advantageous manner in conveying devices, such as pumps and compressors, for liquids and gases, in pneumatic and hydraulic devices and, in particular, as charge-air supply for automotive engines with turbochargers or other intake air-compressing devices.

According to a special embodiment, this adapter can be implemented such that the diameter of the conduit at one adapter end will be larger than that at the other adapter end. This will allow an adaptation of the diameter or of the cross-sectional area in the case of cross-sectional differences between the inlet and the outlet opening, whereby an adaption connection, which provides advantageous flow conditions, will be created between the connections to be interconnected.

In accordance with an advantageous further development, the conduit according to the present invention can be connected to a connection piece having one or a plurality of contact surfaces which are adapted to be used for establishing a sealing contact with the conduit. This allows to establish a connection between the conduit and a further component.

In accordance with different embodiments, contact surfaces can be formed on this connection piece, the everted area of the conduit being adapted to be brought into contact with a complementary inner contact surface and/or a contact surface on the end face and/or an outer contact surface and/or an inclined contact surface and/or a curved contact surface of the connection piece. These embodiments allow the connection between the conduit and the connection piece to be optimally adapted to the respective requirements of use and to the configuration of the eversion.

In accordance with an advantageous embodiment, the connection piece can form a sealing with the conduit at least in the end-face area and/or the outer area and/or an intermediate area of the everted area; this will lead to particularly advantageous contact surfaces for the eversion and to a conduit cross-section having no connection-piece contact surfaces arranged in the interior thereof. A particularly reliable connection can thus be guaranteed, and, in addition, it can also be guaranteed that the volume flow of a medium conveyed will be impaired to a very little extent.

According to another embodiment, the everted area of the conduit and the connection piece can be connected by a non-positive and/or a positive connection, whereby a holding force can be produced, which will hamper or prevent an inadvertent removal of the everted conduit from the connection piece.

In accordance with an advantageous further development, the connection piece can be provided with at least one holding means which engages behind the eversion end area of the everted conduit. Depending on the technical requirements to be satisfied, this holding means can have different structural designs. It may e.g. be implemented as snap ring, spring wire clamp, threaded ring, locking ring, adhesive or bayonet ring, or as a threaded sleeve, locking sleeve, adhesive or bayonet sleeve, as a segmented holding device which can subsequently be attached to the conduit, as attachable or insertable retaining clamps, as clamping or fixing screws or corresponding rivets, as a pivotable mounting bracket, as flexible claws, or as locking projections connected to the connection piece, or as spring clips, press clips or press sleeves. With the aid of these holding means, it is possible to establish an optimum connection between the everted hose and the connection piece, said connection being adapted to the respective intended use in the best possible way.

According to a particularly advantageous further development, this holding means can additionally fulfil a pressure-applying function and press the conduit, axially in the direction of insertion, against a contact surface of the connection piece. This has the effect that a particularly reliable sealing contact between the eversion and an end-face contact surface of the connection piece can be established.

In accordance with another embodiment, the conduit and the connection piece can be connected by a substance-to-substance bond between the connection piece and the conduit, said substance-to-substance bond being established especially by means of glueing or welding the conduit material to the connection piece. This allows a particularly durable and non-releasable connection to be established between the conduit and the connection piece.

As far as the method is concerned, the object of the present invention is achieved by a method for producing a conduit, preferably a flexible hose, said method comprising the following steps:
producing a conduit section,
everting, i.e. folding back or folding inwards, an end area of said conduit section in a plastic state,
solidifying the everted conduit section, preferably by vulcanization or polymerization.

The advantages of the method specified in the present invention are to be seen in the fact that this method can be applied easily and at a reasonable price as well as in the possibility of irreversibly deforming the conduit in a plastic state and of subsequently solidifying this deformation permanently by vulcanization or polymerization thus imparting to the everted area elastic properties and a shape memory and avoiding disadvantageous loads on and changes of the material in the everted area to a large extent.

According to an advantageous embodiment, the conduit end to be everted can be pushed against a shaping device in the plastic state and transponded to the everted state in this way. An advantage of this method is that it can be technically realized in a particularly simple manner.

In accordance with a preferred embodiment, the method is so conceived that, prior to the eversion process, the conduit section can be pushed onto a guide device, preferably a guide mandrel, and that the eversion can be carried out by pushing the conduit end against a shaping device, preferably a die. This allows accurate guidance of the conduit section against the shaping device, and the shape of the non-everted portion of the conduit section can simultaneously be stabilized, whereby e.g. the dimensional accuracy of said non-everted portion of the conduit section can be improved.

According to another further development of the method, the conduit section is subjected to an eversion at both ends, the shaping process being carried out simultaneously at both ends. One advantage of this embodiment is to be seen in that time will be saved, the dimensional accuracy will be improved and in that a holding device, which fixes the central portion of the conduit section and conducts it against the shaping device, will no longer be necessary.

In accordance with a particularly advantageous embodiment of the method, the eversion can take place on a conduit section by making use of a die having a guide mandrel attached thereto and of a second die provided with a guide hole, the conduit section to be everted being pushed onto the guide mandrel of the die having said guide mandrel attached thereto, the length of said guide mandrel exceeding that of the conduit section to be everted and the second die being placed onto said guide mandrel, whereby the guide mandrel is introduced in the guide hole of said second die, the second die being subsequently displaced towards the die having the guide mandrel attached thereto and the conduit section being thus first clamped between the two dies, whereupon the conduit ends of the conduit section are everted on both ends when the die having the guide mandrel attached thereto is advanced still further into the second die. An advantage of this embodiment is that the production method is simplified and expedited still further and that the dimensional accuracy is improved.

The above-mentioned embodiments of the present invention only represent a selection of expedient possibilities of designing the subject matter of the invention. A useful combination of the above-described embodiments results from the references to the respective preceding claims incorporated in the dependent claims.

In the following, the present invention will exemplarily be explained in detail on the basis of a selection of preferred embodiments in combination with the associated figures, in which:

FIG. 1 shows a schematic cross-section through an everted area of a conduit wall,

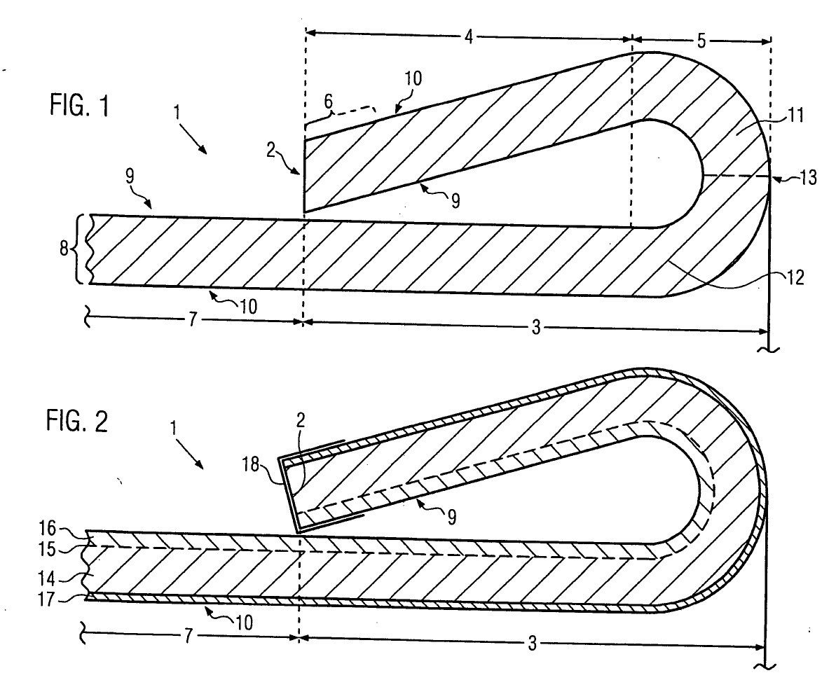

FIG. 2 shows a schematic cross-section through a wall of an everted multi-layered hose of fabric provided with stabilizing means,

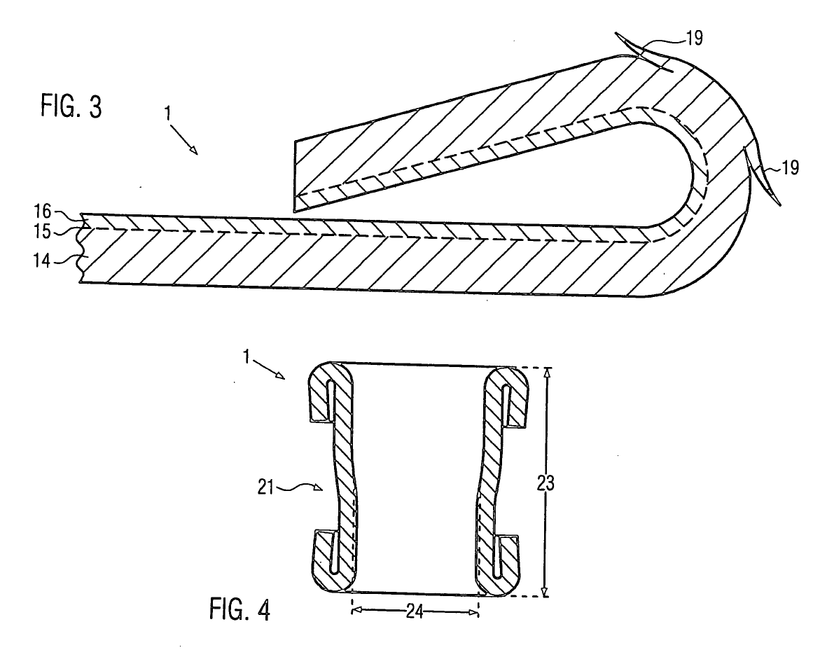

FIG. 3 shows a schematic cross-section through the wall of an everted multi-layered hose of fabric having sealing lips formed thereon,

FIG. 4 shows a schematic representation of a median section in an axial plane through an adapter with a conduit having an eversion on both ends thereof,

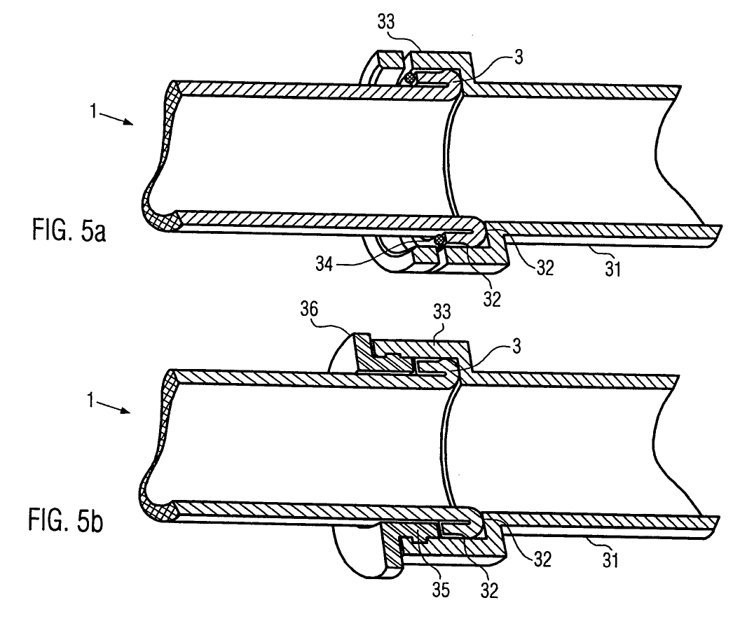

FIG. 5a shows a schematic representation of a median section in an axial plane through an everted conduit with a conduit connection piece provided with a spring wire clamp,

FIG. 5b shows a schematic representation of a median section in an axial plane through an everted conduit with a conduit connection piece provided with a bayonet ring,

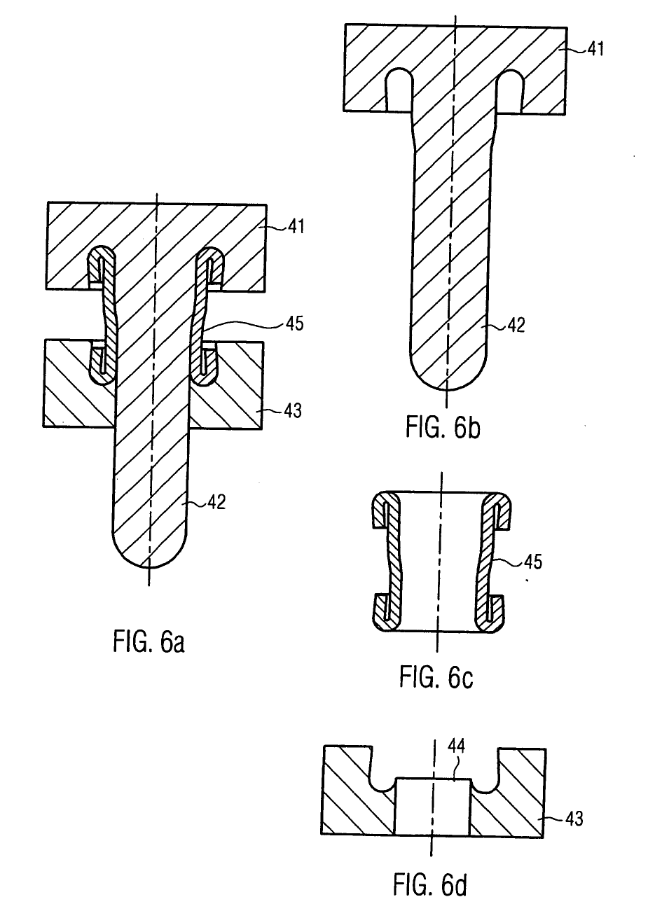

FIG. 6 a-d show schematic representations of a shaping device for producing a conduit section having an eversion on both ends thereof.

FIG. 1 shows a schematic cross-section through the wall of a conduit 1 in the everted area 3 of a first embodiment of the present invention; the representation of the opposite conduit wall of the rotationally symmetric conduit has been dispensed with, since it corresponds to a view of the depicted portion, axially reflected.

In FIG. 1 a conduit 1 can be seen, which has an outer wall 9 and an inner wall 10. In the everted area 3 shown, the conduit 1 has been subjected to an eversion, which has the effect that the orientations of the outer wall 9 and of the inner wall 10 in an everted portion 11 will be reversed with regard to those of a non-everted portion 12 relative to an imaginary centre line or axis of the conduit 1, which represents the axis of rotation of the rotationally symmetric conduit 1, whereupon either the original outer walls 9 or the original inner walls 10 of the everted portion 11 and of the non-everted portion 12 will face one another.

The everted area 3 extends from a distal end 13 of said everted area 3 of the everted conduit 1 in proximal direction up to an imaginary line connecting the respective most proximal points of the everted portion 11 of one side of the conduit wall to the corresponding point of the opposite side of the conduit wall and comprising the everted portion 11 and the non-everted portion 12. Furthermore, the conduit 1 comprises a continuative portion 7 which proximally adjoins the everted area 3.

The everted area 3 additionally comprises a conduit end 2, an eversion end area 6 and a bent area 5. Furthermore, the everted portion 11 can comprise a straight portion 4 in accordance with a preferred embodiment. The cut edge of the conduit in the everted portion 11 is referred to as conduit end 2. The eversion end area 6 consists of a subportion of the everted portion 11, said subportion bordering on said conduit end 2. The bent area 5 is a subportion of the everted area 3, which comprises the distal end 13 of said everted area 3 and which is characterized in that the conduit wall has a strong curvature, when seen in a cross-sectional view. The straight portion 4 bordering on said bent area 5 in the everted portion 11 comprises the remaining subportion of the everted portion 11 of the everted area 3, in which the conduit wall is approximately straight. The conduit 1 additionally has a wall thickness 8, which is to be determined in the continuative portion 7.

In addition to the above-mentioned first embodiment, further variants are possible and expedient; the most important ones of these variants will exemplarily be described in the following, with short explanations:

according to one variant of the first embodiment, the eversion 3 is implemented such that the everted portion 11 abuts sectionwise on the non-everted portion 12 and is in contact therewith. The everted portion 11 and the non-everted portion 12 will thus stabilize one another in an advantageous manner, and this will especially prevent the everted portion 11 from radially swerving when pressure is applied to the conduit end 2 in the axial direction.

According to another variant, the eversion is implemented such that its radius of inner curvature tends to zero; this has the effect that the everted portion 11 abuts on the non-everted portion 12 almost along the entire length thereof. Alternatively, the everted area 3 may, however, also be implemented with a larger radius of inner curvature, whereby a cavity will be formed in the inner area of the curvature, into which e.g. some other component can be introduced or with which some other component can be in engagement. This structural shape can also be used e.g. in cases where major deformations of the hose wall and/or an excessive compression of the hose layer located in the inner area of the curvature and/or an excessive elongation of the hose layer located in the outer area of the curvature is/are to be avoided. Another advantage obtained is a higher elasticity of the bent area 5, whereby sealing surfaces which can be adapted more easily to a neighbouring component can be formed in the bent area 5 of the conduit. Moreover, this variant can be implemented such that the conduit end 2 abuts on the non-everted portion 12 and is in contact therewith.

In accordance with a further possibility of implementing the above-mentioned embodiment, the conduit end-side portion of an everted portion 11 can terminate in a straight portion 4, whereby a pressing force, which is applied to the conduit end 2 in a direction parallel to the wall and which is transmitted to the bent area 5, will be transmitted more effectively and press the end-face area of the eversion in the bent area 5 against a contact surface of an adjoining component.

This straight portion 4 can also be implemented as a parallel portion, the respective wall layers of a non-everted portion 12 and of an everted portion 11 being then arranged approximately parallel to one another in this area, whereby this parallel portion will be oriented parallel with regard to the above-mentioned pressing force. In certain cases, an embodiment may be of advantage in which the everted portion 11 does not abut on the non-everted portion 12 so that a circumferentially extending annular gap is formed between the conduit end and the non-everted portion; hence, it will be possible to insert e.g. one or a plurality of elements into this gap or to arrange them in said gap or to bring them into engagement therewith.

The eversion is not limited to a single eversion, but it may also be implemented such that more than one eversion is formed, whereby more than two wall layers will adjoin one another in the everted area 3. This kind of structural design will additionally stabilize the everted area 3 and increase the thickness thereof. It is also possible to imagine a further development of the above-mentioned embodiment in the case of which the conduit end 2 is everted by rolling in, whereby, when seen in a cross-sectional view, an approximately spiral mode of arrangement of the wall layers in the everted area 3 is obtained. A particularly resilient embodiment of the enlarged portion in the form of a round bead can be produced in this way. Likewise, it would also be imaginable to elongate, compress or squeeze the everted area, at least in certain subportions or sections thereof, or to deform it in some other way, or to additionally apply material thereto or remove material therefrom, so as to further influence its characteristics.

Materials which can be used for such a conduit 1 according to embodiments of the present invention are in particular synthetic materials of all kinds, such as thermosetting materials, thermoplastics, thermoplastic elastomers, elastomers, copolymers and composite materials. Depending on the respective field of use, embodiments of the conduit 1 can be implemented as a single-layered or as a multi-layered conduit.

The shape of the conduit 1 according to the present invention is not limited to round cross-sections, but embodiments are imaginable which have especially an oval cross-section or a box-shaped cross-section or other cross-sectional shapes; for special cases of use, varying cross-sections may be employed as well. Likewise, the conduits 1 need not necessarily be straight conduits 1, but they may have bends or even an arbitrary shape in the continuative portion 7. Furthermore, in specific embodiments of the present invention, the conduits 1 may vary in different sections thereof not only with regard to their shape but also with regard to the composition of material or the application of additional layers.

In addition, all the above-mentioned eversion variants may also be used for both ends of a piece of conduit.

The conduit 1 of the first embodiment can consist of a large number of materials, provided that these materials fulfil the requirement that they have a plastic state in which the end portion can be everted, and that, after the execution of this deformation, this plastic state can be transponded to some other state, e.g. a comparatively rigid or elastic state, whereby the deformation can be stabilized or solidified.

In many cases, it will be desirable to implement the conduit 1 as a flexible component and as a flexible hose; such a conduit will normally contain an elastomer or a thermoplastic elastomer or a thermoplastic, and the eversion will have been executed prior to the vulcanization or the polymerization so as to stabilize the shape of the everted area. Such flexible hoses 1, which are used for the eversion described in the present connection, are preferably produced in an extrusion process.

FIG. 2 shows a corresponding cross-section through the wall of a conduit—which is here implemented as a flexible hose—in the everted area 3 according to a second embodiment of the present invention. This second embodiment corresponds to the first embodiment with regard to essential points so that reference numerals as well as statements concerning the first embodiment apply to the second embodiment as well. In order to avoid repetitions, only the differences and the particularities of this second embodiment will therefore be dealt with.

In comparison with the first embodiment, the second embodiment additionally comprises a stabilizing means 18 on the conduit end 2 of the flexible hose. In addition, the conduit is implemented as a flexible hose and has a four-layered structural design comprising the following layer sequence from the inner surface to the outer surface of the hose: blocking layer 17, inner layer 14, reinforcement layer 15, outer layer 16.

In connection with this second embodiment, which is implemented as a flexible hose, a plurality of variants, which are exemplarily described in the following, will again be expedient. The conduit can consists of a single-layer hose 1 made of thermoplastics, thermoplastic elastomers or elastomers, said hoses being particularly economy-priced as far as the production and the subsequent eversion processing are concerned. In order to improve especially the mechanical properties of the flexible hose 1 in the respective field of use, it may be expedient to make use of a multi-layered embodiment of a hose; for this purpose, a plurality of layers 14, 16, 17 consisting of different synthetic materials can be used, or/and the hose can include a reinforcement layer 15 consisting e.g. of a fabric comprising fibres that are resistant to tension.

According to a variant representing a further development, the flexible hose 1 may preferably also be provided with a blocking layer 17 on the inner surface and/or on the outer surface thereof; materials that are suitable for this blocking layer 17 are e.g. elastomeric copolymers, preferably rubber copolymers, or a halogen-containing rubber, preferably fluorocarbon rubber, so as to make this flexible hose 1 particularly resistant to certain chemicals, reduce the diffusion of said chemicals, and/or increase the mechanical or thermal stability. It can be particularly advantageous to provide the blocking layer on the inner surface of the hose so that, when said hose has been everted, it will cover the outer area of the eversion and improve thus the leak-tightness in the connection area to a neighbouring component.

It will be advantageous to select the flexibility of the flexible hose 1 such that the flexibility of the everted area 3 does not exceed that of a continuative portion 7.

Other variants concern the use of stabilizing means 18 with the aid of which the everted area 3 can be stabilized. The stabilizing means 18 can here be arranged in the everted area 3 at least sectionwise between the wall layers of the non-everted portion 12 and of the everted portion 11, it may also extend between the wall layers of the non-everted portion 12 and of the everted portion 11 from the conduit end 2 to the end of the bent area 5 located remote from the conduit end 2 and may be implemented such that an axial pressing force directed towards the distal end 13 of the everted area 3 can be introduced in the stabilizing means 18 and that this force will directly be transmitted to the wall of the bent area 5, said bent area 5 being then clamped between the stabilizing means 18 and an adjoining component and pressed onto said adjoining component, and it may also be provided in the bent area 5 and reinforce said area, it may be in contact with the cut edge of the conduit end 2 thus stabilizing said cut edge and increasing the suitability for the introduction of a pressing force which presses the end face of the eversion on the distal end 13 of the everted area 3 against a component which is in contact with said end face, and/or it can encompass the eversion end area 6, which is not located between the wall layers of the non-everted portion 12 and of the everted portion 11, thus preventing said area 6 from being widened. The structural design of the stabilizing means 18 can thus be adapted to the respective technical requirements that have to be satisfied in the specific case of use.

According to an advantageous embodiment, said above-mentioned stabilizing means 18 can be implemented as a sleeve, which consists preferably essentially of a metal or a metal alloy and which, if necessary, may also be heat treated, or provided with a protective coating or an adherent coating, or which may have been subjected to some other kind of surface treatment or provided with some other kind of coating. An embodiment comprising a synthetic material as a basic material or consisting of a composite material would be imaginable as well. In the case of other variants of the stabilizing means 18, said stabilizing means 18 or other elements can be connected to the conduit by non-positive locking, by positive locking and/or by means of a substance-to-substance bond; the stabilizing means 18 can, for example, have a surface design that enhances positive locking, or said stabilizing means 18 may be connected to a portion of the conduit by pressing or by means of an adhesive. Furthermore, variants of the invention are possible in the case of which the everted portion 11 is connected to the non-everted portion 12 by means of welding or by means of an adhesive so as to stabilize the everted area 3.

FIG. 3 shows a conduit, which is implemented as a flexible multi-layered conduit, according to a third embodiment of the present invention. This third embodiment corresponds to the first two embodiments with regard to essential points so that reference numerals as well as statements concerning these first two embodiments apply to the third embodiment as well. In order to avoid repetitions, only the differences and the particularities of this third embodiment will therefore be dealt with.

The embodiment shown in FIG. 3 shows a hose 1 consisting of an outer layer 16, a reinforcement layer 15 and an inner layer 14, said hose being provided with a sealing means; in the pictorially represented variant of the embodiment, this sealing means is implemented in the form of two sealing lips 19. It will be advantageous to form these sealing lips 19 by incising the conduit wall after the vulcanization or polymerization at an oblique angle to the surface of said conduit wall along a line that is rotationally symmetric relative to the axis of the conduit, whereby a position of the incision line will be obtained, which, in a transverse plane, is concentric to the section lines through the conduit wall. The sealing lip 19 may also be arranged such that, in the case of high pressures in the interior of the conduit, it will move into contact with or press against an adjoining component, whereby the sealing effect will be increased. Alternatively, the sealing lips 19 may also be formed during the solidification process, e.g. in a vulcanizing mould.

According to another variant, this sealing means in the everted area 3 of the hose 1 can also comprise other types of sealing means. These other types of sealing means may e.g. be sealing rings or sealing gaiters, which may also be connected to the everted area by a substance-to-substance bond, sectionwise applied sealing or blocking layers consisting of a synthetic material that is suitable for the specific intended use, sealing coatings which may be produced e.g. in an immersion process, or e.g. hydrophobic or lipophobic finishings or coatings for improving the sliding properties or for reducing abrasion.

FIG. 4 shows as a fourth embodiment a conduit 1 of the type shown and described in the preceding embodiments, preferably a flexible hose, said conduit or hose having an eversion on both ends. It follows that the statements made in connection with the first to third embodiments apply to this fourth embodiment as well. In order to avoid repetitions, only the differences and the particularities of this fourth embodiment will therefore be dealt with.

The adapter 21 has an adapter length 23 and a conduit internal diameter 24. If the inner wall of the conduit does not have the shape of a cylinder jacket, the conduit internal diameter 24 will be ascertained by calculating the averaged diameter which can be determined on half the adapter length 23. The preferred ratio of adapter length 23 to conduit internal diameter 24 should typically be smaller than 10:1, preferably smaller than 3:1. As far as the structural design of the adapter 21 is concerned, the above-mentioned embodiments 1 to 3 can be resorted to.

Such adapters 21 can advantageously be used for connecting components and for providing mechanical, thermal and/or electrical decoupling at the same time. Such an adapter 21 can especially be used for damping vibration transmission from one component to the next, as a damping element for absorbing pressure peaks in the pressure flow of the media conveyed, for compensating tolerances and thermal stresses and/or for adaptation to diameter differences. A special field of use for such an adapter 21 can be connection conduits of conveying devices, such as pumps and compressors; another specially preferred field of use is given in the field of charge-air supply for automotive engines with turbochargers or other intake air-compressing devices.

FIG. 5a shows the use of a conduit 1 according to the second embodiment in combination with a connection piece 31 and a spring wire clamp 34. As can be seen from the figure, the conduit 1 has its everted area 3 introduced in a conduit reception area 33 of the connection piece 31, the end face and the outer side of the everted area 3 abutting on and being in sealing contact with corresponding contact surfaces 32 of the connection piece 31. The conduit reception area 33 of the connection piece includes segmental recesses which are provided on opposed portions of the conduit wall and which are suitable for accommodating a spring wire clamp 34, said spring wire clamp engaging behind the conduit end 2 of the eversion end area 6, thereby protecting the conduit 1 from being pulled out of the conduit reception area 33 of the conduit connection piece 31.

FIG. 5b shows again the use of a conduit 1 according to the second embodiment in combination with another variant of a connection piece 31 in the case of which a bayonet ring 35, instead of the spring wire clamp 34, is used for executing the securing function and for pressing the everted area 3 against the contact surfaces 32 of the connection piece 31; this bayonet ring 35 engages the gap defined between the continuative portion 7 of the conduit 1 and a portion of the wall area of the conduit reception area 33 and applies pressure to the conduit end 2 of the eversion end area 6, whereby a reliable pressure contact between the end face area of the everted area 3 of the conduit 1 and the complementary axial contact surface 32 of the connection piece 31 can be achieved. The bayonet ring 35 additionally comprises a collar 36 in an area facing away from the contact surface between the bayonet ring 35 and the everted area 3 in the axial direction of the conduit; said collar 36 is characterized in that the diameter increases abruptly towards the outside and it is implemented as a gripping section 36 that can be gripped, when the bayonet joint is being locked and unlocked.

According to an advantageous embodiment, the connection piece 31 can also be implemented such that no inner nipple is provided thus avoiding a narrowing of the lumen in the flow cross-section between the conduit 1 and the connection piece and establishing the sealing contact between the everted area 3 of the conduit 1 and the conduit connection piece 31 in the end-face and/or outer area of the everted area 3 or in a curved area of the everted area 3 with a complementary end-face axial contact surface or outer contact surface or with an inclined or curved contact surface of the connection piece 31. According to a special variant, the contour of the contact surfaces is sectionwise adapted to the bent area 5 of the everted area 3 and a complementary negative form to said bent area 5 is created such that the lumina of said conduit 1 and of the connection piece 31 can adjoin one another without any gap that would be worth mentioning being formed therebetween. Furthermore, an arbitrary combination of contact surfaces within the connection piece 31 in one embodiment is imaginable as along as a contact between an area of the everted area 3 and the connection piece 31 is established.

For fixing the conduit 1 in the connection piece 31, different variants, which are known in the field of technology, are imaginable, by means of which a non-positive and/or positive connection is established between the contact surfaces 32 and an area of the everted area 3. These known variants comprise e.g. connections established by pressing and/or tooth profiles or other prefabricated shapes of the contact surfaces.

According to a particularly advantageous structural design of the connection piece 31, said connection piece 31 comprises holding means that engage behind the eversion end area 6. The elements that may be used for this purpose are especially the following ones: snap rings, spring wire clamps 34, threaded rings, locking rings, adhesive or bayonet rings 35 or respective threaded sleeves, locking sleeves, adhesive or bayonet sleeves, segmented holding devices, which can subsequently be placed round the continuative portion 7 of the conduit 1, retaining clamps that can be introduced between the conduit reception area 33 of the connection piece 31 and the continuative portion 7 of the conduit 1, furthermore, clamping or fixing screws or rivets, mounting brackets which are rotatably supported in the conduit reception area 33 of the connection piece 31 or which are movable in some other way, or movably supported spring clamps, claws which are movably connected to the conduit reception area 33 of the connection piece 31, locking projections or locking rings, spring clips or pressable areas which may be implemented e.g. as press sleeves or press clips.

Many of the above-mentioned holding means can be implemented such that they additionally fulfil a pressure-applying function and press the conduit 1, axially in the direction in which the conduit is inserted, against a contact surface 32 of the connection piece 31. Depending on the respective structural design of the holding means, it is thus possible to obtain a fast-release connection, a connection that can be released by hand, a connection that can be released by standard tools, a connection that can only be released by special tools, or a non-releasable connection. For providing a non-releasable connection, it is also possible to use a substance-to-substance bond between the connection piece 31 and the conduit 1, said substance-to-substance bond being established especially by means of glueing or welding.

Depending on the respective field of use, the materials which are adapted to be used as a material for the conduit connection piece 31 are especially metals and metal alloys, synthetic materials and composite materials, in particular fibre composite materials, and also ceramic materials, glass or sintered materials. For some cases of use, it may be expedient to use for the connection piece 31 a synthetic material which is similar to or which corresponds to the kind of material that has been used for the conduit itself. The conduit reception area 33 of the connection piece 31 may also be produced from a shrinkable plastic portion, whereby a positive connection between the everted area and the conduit reception area would be obtained. In addition, the conduit reception area may also contain a meltable adhesive which establishes a substance-to-substance bond in the everted area.

FIG. 6 a-d show an embodiment of a method for producing an adapter 21 according to a fourth embodiment, which comprises the following steps:
producing a conduit section 45,
everting an end area of said conduit section 45 in a plastic state,
solidifying the everted conduit section 45, preferably by vulcanization or polymerization.

A device of the type shown in FIG. 6 can advantageously be used for the step of everting the conduit end section of a conduit section 45 on both sides thereof in a plastic state.

FIG. 6 a-d show a shaping device implemented as a die 41 with an annular recess, which, when seen in a median section, has a substantially archway-shaped cross-section, as a complementary countershape to the eversion of the conduit which is to be carried out in the conduit end area, a guide mandrel 42 attached thereto and comprising the whole central, non-recessed area of the die, the diameter of said guide mandrel 42 being adapted to the internal diameter of the end of the conduit section and the length of said guide mandrel being dimensioned such that it extends through the attached, non-everted conduit section 45 to such an extent that it is possible to establish a guidance fit between the guide mandrel portion extending through the not yet everted conduit section 45 and a second die 43 provided with a recess which is similar to that provided in the die 41, said second die 43 having, however, in the central area thereof a guide hole as a mating hole for the guide mandrel 42, instead of said guide mandrel 42. The method executed at the conduit section 45 is carried out such that said conduit section 45 is first pushed onto the guide mandrel 42, whereupon said guide mandrel 42 is inserted into the complementary guide hole 44 of the second die 43, whereupon the die 41 having the guide mandrel 42 attached thereto is moved towards the second die 43; this has the effect that the conduit section 45 is first clamped between the two dies 41 and 43; in this condition, the conduit wall of the conduit section 45 is in contact with the guide mandrel 42 and is prevented from swerving; when the die 41 having the guide mandrel 42 attached thereto is advanced still further into the second die 43, the conduit ends of the conduit section 45 are, due to the rounded part of the recess in the dies 41 and 43, at both ends successively bent open, folded backwards and everted in one operation.

Depending on the use of the respective conduit material, conduit length, conduit structure, the numbers of pieces produced and available machines, etc., a large number of alternative production methods are described by claim 32 and can be adapted according to the respective production requirements. Hence, a few further expedient method variants will be enumerated hereinbelow.

According to one variant of the production method, a rigid die 41, 43 is used for everting the conduit end, the conduit end to be everted being displaced relative to said rigid die. Alternatively to the use of a die 41, 43, it would also be possible to use a shaping device which is adapted to undergo changes of shape and which additionally supports the eversion process of the conduit end by undergoing a change of shape itself. In many cases, it will be expedient to combine the shaping device with a guiding device for forwarding and stabilizing the non-everted, i.e. not yet everted conduit; this can be done by guiding the forwarded conduit on the outer and/or on the inner surface thereof; this guidance can also be combined with a holding and advancing function for the conduit relative to the shaping device. In certain cases it will also be expedient when this guiding function is performed by a guide mandrel 42 which is positioned relative to a die 41, 43 and which is advantageously connected to said die. Depending on the conduit length, the kind of conduit, the numbers of pieces produced and the machine facilities, it may, in the case of eversion at both ends, be expedient to carry out the eversion process at both ends simultaneously, which will allow a timesaving production process, or to execute these eversions one after the other.

According to a further variant of the production method according to the present invention, the eversion is carried out in a plurality of steps; according to another embodiment of said method, the everted area 3 is, after the eversion, additionally compressed or squeezed or deformed in some other way, so as to further influence its shape. In accordance with a special variant, the eversion process will be carried out on a partially solidified conduit section, or with sequential solidification, if the shape of the everted portion and the conduit used make such a method appear expedient. If thermoplastic synthetic materials are used, the eversion process will, according to a special embodiment of the production method according to the present invention, also take place as thermal deformation of the heated conduit material. This heating may also be effected in a locally limited manner or during the deformation process, or it may be take place within the shaping device.

1. A conduit, preferably a flexible hose, wherein the conduit is, at least sectionwise, provided with an eversion in an end portion thereof, said conduit having been everted in a plastic state prior to a solidification by means of which said eversion is fixed.

2. A conduit according to claim 1, wherein a section of the eversion is in contact with the conduit on a non-everted portion.

3. A conduit according to claim 1, wherein, after the eversion, an everted portion is in contact with the non-everted portion of the conduit only in a section including the conduit end.

4. A conduit according to claim 1, wherein the eversion has been carried out such that a section of an everted portion located on the side of the conduit end terminates in a straight portion.

5. A conduit according to claim 1, wherein the straight portion is a parallel portion which is wherein the respective wall layers of a non-everted portion and of an everted portion extend substantially parallel to one another in this area.

6. A conduit according to claim 1, wherein the everted portion is not in contact with the non-everted portion.

7. A conduit according to claim 1, wherein the eversion has been performed outwards so that the original outer conduit walls of the non-everted portion and of the everted portion face one another.

8. A conduit according to claim 1, wherein a multiple eversion is carried out and wherein more than two wall layers adjoin one another in the everted area.

9. A conduit according to claim 1, wherein the eversion is performed by rolling in the conduit end and wherein the wall layers in the everted area are arranged in an approximately spiral mode of arrangement, when seen in a cross-sectional view.

10. A conduit according to claim 1, wherein at least one stabilizing means, by means of which the eversion can be stabilized, is provided in the everted area.

11. A conduit with stabilizing means according to claim 1, wherein the stabilizing means is arranged in the everted area, at least sectionwise, between the wall layers of the non-elected portion and of the everted portion.

12. A conduit with stabilizing means according to claim 1, wherein the stabilizing means is in contact with the conduit end at the cut edge thereof.

13. A conduit with stabilizing means according to claim 1, wherein the stabilizing means encompasses the everted portion at the inner conduit side facing outwards.

14. A conduit according to claim 1, wherein the stabilizing means is an encompassing means, preferably a sleeve, said sleeve being preferably a metal sleeve.

15. A conduit according to claim 1, wherein the conduit is a flexible hose and contains at least an elastomer, a thermoplastic electomer or a thermoplastic, and wherein the eversion has been executed prior to a vulcanization or polymerization.

16. A conduit according to claim 15, wherein the flexible hose is produced in an extrusion process.

17. A conduit according to claim 15, wherein the flexible hose is a multi-layered hose of fabric comprising at least an inner layer, a reinforcement layer and an outer layer, said inner layer and/or outer layer containing an electomer or a thermoplastic elastomer or a thermoplastic.

18. A conduit according to claim 15, wherein the flexible hose includes a blocking layer.

19. A conduit according to claim 18, wherein the blocking layer is arranged on the inner side of the hose.

20. A conduit according to claim 18, wherein the blocking layer contains a rubber copolymer, or a halogen-containing rubber, preferably a fluorocarbon rubber.

21. A conduit according to claim 1, wherein the flexibility of the everted area does not exceed that of a continuative portion.

22. A conduit according to claim 1, wherein a sealing area comprising a sealing means is formed in the everted area.

23. A conduit according to claim 22, wherein the sealing means represents a sealing lip, said sealing lip being preferably formed by incising the conduit wall.

24. A conduit according to claim 1, wherein the preferred ratio of the length of the everted area to the wall thickness of the conduit is between 2.5:1 and 20:1.

25. A conduit, preferably a flexible hose, according to claim 15, wherein the conduit is provided with an eversion on both ends thereof.

26. A conduit according to claim 25, wherein the ratio of adapter length to conduit internal diameter is typically smaller than 10:1, preferably smaller then 3:1.

27. A conduit according to claim 25, wherein the diameter of the conduit at one end portion of the conduit is larger than that at the other end portion of the conduit.

28. A conduit provided with a connection piece, wherein the conduit is produced according to claim 1, and wherein this conduit is connected to the connection piece and establishes a sealing contact with a contact surface of the connection piece.

29. A conduit provided with a connection piece according to claim 28, wherein the everted area is adapted to be brought into contact with a complementary inner contact surface and/or a contact surface on the end face and/or an outer contact surface and/or an inclined contact surface and/or a curved contact surface of the connection piece.

30. A conduit provided with a connection piece according to claim 28, wherein the sealing is formed between the connection piece and the conduit at least in the end-face area and/or the outer area and/or an intermediate area of the everted area.

31. A conduit provided with a connection piece according to claim 28, wherein the everted area and the connection piece are connected by a non-positive and/or a positive connection.

32. A conduit provided with a connection piece according to claim 28, wherein the connection piece includes a holding means which engages behind the eversion end area.

33. A conduit provided with a connection piece and a holding means according to claim 32, wherein the holding means additionally fulfils a pressure-applying function and presses the conduit, axially in the direction of insertion, against a contact surface of the connection piece.

34. A conduit provided with a connection piece according to claim 28, wherein a substance-to-substance bond is established between the connection piece and the conduit, said substance-to-substance bond being established especially by means of glueing and welding.

35. A method for producing a conduit according to claim 1, said method comprising the following steps:
producing a conduit section,
everting an end area of said conduit section in a plastic state, and
solidifying the everted conduit section, preferably by vulcanization or polymerization.

36. A method according to claim 35, wherein the conduit end to be everted is pushed against a shaping device in the plastic state.

37. A method according to claim 35, wherein the eversion is carried out by pushing the conduit section onto a guide device, preferably a guide mandrel, and by pushing the conduit end against a shaping device, preferably a die.

38. A method according to claim 37, wherein, for forming an eversion at both ends, the shaping process is executed simultaneously at both ends.

39. A method according to claim 37, wherein, for executing the eversion on the conduit section, a die having a guide mandrel attached thereto and a second die provided with a guide hole are used, and wherein the conduit section to be everted is pushed onto the guide mandrel of the die having said guide mandrel attached thereto, the length of said guide mandrel exceeding that of the conduit section to be everted, and wherein the second die is placed onto said guide mandrel, whereby the guide mandrel is introduced in the guide hole of said second die, and wherein, subsequently, the second die is displaced towards the die having the guide mandrel attached thereto and the conduit section is first clamped between the two dies, whereupon the conduit ends of the conduit section are everted on both ends when the guide mandrel is advanced still further.
